(19) United States
(12) Patent Application Publication
(10) Pub. No.: US 2025/0332489 A1
(43) Pub. Date: Oct. 30, 2025

(54) PICKLEBALL TESTING DEVICE

(71) Applicants: WEI-LONG CHEN, Taichung City (TW); Tri-Great International Ltd., Taipei City (TW)

(72) Inventors: Wei-Long CHEN, Taichung City (TW); YAO-CHI MU, Taichung City (TW)

(21) Appl. No.: 18/746,456

(22) Filed: Jun. 18, 2024

(30) Foreign Application Priority Data
Apr. 26, 2024 (TW) 113115721

(51) Int. Cl. A63B 47/00; A63B 102/08; G01B 5/00

(52) U.S. Cl. CPC A63B 47/008; A63B 2102/08; G01B 5/0023

(57) ABSTRACT

A pickleball testing device having an airflow generating unit and an airflow circulating unit. The airflow generating unit includes a turbine fan and a base that supports the turbine fan and supplies power to the turbine fan. The turbine fan and the base are covered by an outer casing, and the upper side of the outer casing features a protruding connection member. The airflow circulating unit comprises an airflow channel which is a hollow tubular column, and the lower end of which is connected to the connection member. The turbine fan generates an airflow, then transfers the airflow to the connection member, causing the flow of air to move upward along the airflow channel.

### FIELD OF INVENTION

The present invention relates to a ball testing device, especially to a pickleball testing device.

### BACKGROUND OF THE INVENTION

Pickleball is a hybrid sport that combines elements of table tennis, badminton, and tennis. The sport originated in the United States, and due to its relatively simple rules, ease of learning, suitability for all ages, and ability to promote social interaction between people, pickleball has gradually become a global craze, becoming a popular choice for many people in their leisure time, and also having professional tournaments and leagues.

In a pickleball game, players can use special tactics and techniques, such as controlling the spin and speed of the ball, to alter its trajectory and confuse the opponent, creating various offensive and defensive strategies. To enhance the maneuverability of pickleball, some inventions have improved pickleball paddles by adjusting their friction, and pickleballs produced by different manufacturers also vary considerably, such as the softness or hardness of the ball, the size and number of holes, etc. Different manufacturing processes may also result in uneven thickness or uneven bonding on the surface of the pickleball. In addition, after use, the surface of the pickleball can wear down and affect its maneuverability and even the fairness of pickleball competitions. To standardize the sport of pickleball, the relevant associations have proposed some regulations and standards for pickleball. However, there is currently no method to quickly determine whether a pickleball meets the standards or to assist manufacturers in quality control of pickleballs.

In view of the above, the development of a pickleball testing device has become an urgent goal in the relevant field.

### SUMMARY OF THE INVENTION

In order to achieve the goal of quickly determining whether a pickleball conforms to standards or assisting manufacturers in quality control of pickleballs and confirming the degree of deformation or wear caused by use that changes the performance of the pickleball, the present invention provides a pickleball testing device comprising an airflow generating unit and an airflow circulating unit, wherein: the airflow generating unit comprises a turbine fan and a base that supports the turbine fan and supplies power to the turbine fan, the turbine fan and the base being covered by an outer casing, and the upper side of the outer casing featuring a protruding connection member; and the airflow circulating unit comprises an airflow channel that is a hollow tubular column, and the lower end of the airflow channel is connected to the connection member; wherein: the turbine fan generates an airflow, then transfers the airflow to the connection member, causing the flow of air to move upward along the airflow channel.

The airflow channel is a hollow cylinder, and the upper end of the airflow channel contains multiple straightening tubes extending along the axial direction of the airflow channel, the straightening tubes dividing the airflow channel along the axial direction into multiple tubular channels.

The outer casing includes a level.

The diameter of the cross-section of the airflow channel is between 5 centimeters and 10 centimeters.

The cross-section formed by each straightening tube in the airflow channel exhibits multi-axial symmetry, and the cross-sectional area of each straightening tube is less than 1 square centimeter.

Each of the straightening tubes forms an end face at the upper end of the airflow channel, with the end face sloping downward from the outer wall of the airflow channel toward the axis of the airflow channel to form a concave surface.

The outer casing includes a mask which is penetrable, and the surface of the mask includes one or more scales.

The airflow generated by the turbine fan has a flow rate between 10 kilometers per hour and 100 kilometers per hour when exiting the airflow channel.

The pickleball testing device further comprises an imaging module, which has one or more cameras facing the upper end of the airflow channel to capture or record an image, and an image recognition system to identify the image.

The pickleball testing device further comprises a photoelectric sensing device for detecting the position at the upper end of the airflow channel, the photoelectric sensing device containing a laser beam emitter.

The laser beam emitter is attached to the connection member and emits a laser beam toward the direction of the airflow channel, the laser beam being parallel to the airflow channel

From the above description, it can be seen that the present invention has the following features:

1. The pickleball testing device in accordance with the present invention enables the user to quickly confirm the condition of the pickleball in use, determine whether the pickleball has deformed or worn to an unusable condition, facilitate timely replacement of the ball, and ensure the fairness of the competition through real-time ball inspection.

2. The pickleball testing device in accordance with the present invention can assist manufacturers in quickly inspecting the quality of the manufactured pickleballs, ensuring that the pickleballs meet the specified standards and that the properties of each pickleball are consistent and stable.

3. The pickleball testing device in accordance with the present invention can be used to assist in the development and testing of pickleballs, to quickly obtain the condition of pickleballs with different processes, different materials, different hole sizes, different numbers of holes, and different manufacturing processes, thereby optimizing the pickleball.

### BRIEF DESCRIPTION OF THE DRAWINGS

FIG. 1A is a perspective view of a preferred embodiment of The pickleball testing device in accordance with the present invention;

FIG. 1B is a partial perspective view of a preferred embodiment of The pickleball testing device in accordance with the present invention;

FIG. 1C is a partial perspective view of a preferred embodiment of The pickleball testing device in accordance with the present invention;

FIG. 1D is a perspective view of a preferred embodiment of The pickleball testing device in accordance with the present invention;

FIG. 1E is a partial perspective view of a preferred embodiment of The pickleball testing device in accordance with the present invention;

FIG. 1F is a partial perspective view of a preferred embodiment of The pickleball testing device in accordance with the present invention;

FIG. 1G is a perspective view of a preferred embodiment of The pickleball testing device in accordance with the present invention and a schematic diagram of multiple laser beams;

FIG. 2A is an exploded perspective view of a preferred embodiment of The pickleball testing device in accordance with the present invention;

FIG. 2B is an exploded perspective view of a preferred embodiment of The pickleball testing device in accordance with the present invention;

FIG. 3A is a cross-sectional view of a preferred embodiment of The pickleball testing device in accordance with the present invention; and

FIG. 3B is a cross-sectional view of a preferred embodiment of The pickleball testing device in accordance with the present invention.

### DETAILED DESCRIPTION OF THE PREFERRED EMBODIMENTS

In order to more clearly explain the technical solutions of the embodiments of the present invention, a brief introduction to the drawings required in the descriptions of the embodiments is provided below. It is understood that the drawings in the following descriptions are merely some examples or embodiments of the present invention. Those skilled in the art will be able to apply the present invention to other similar scenarios without creative effort on the basis of these drawings. Unless it is apparent from the language environment or otherwise stated, the same reference numbers in the figures represent the same structures or operations.

As shown in the present invention and claims, unless the context clearly indicates otherwise, the terms “a,” “an,” “one,” or “the” do not specifically refer to the singular, but may also include the plural. In general, the terms “comprising” and “containing” indicate only the inclusion of the explicitly identified steps and elements, and these steps and elements do not constitute an exclusive list; the method or apparatus may also include other steps or elements.

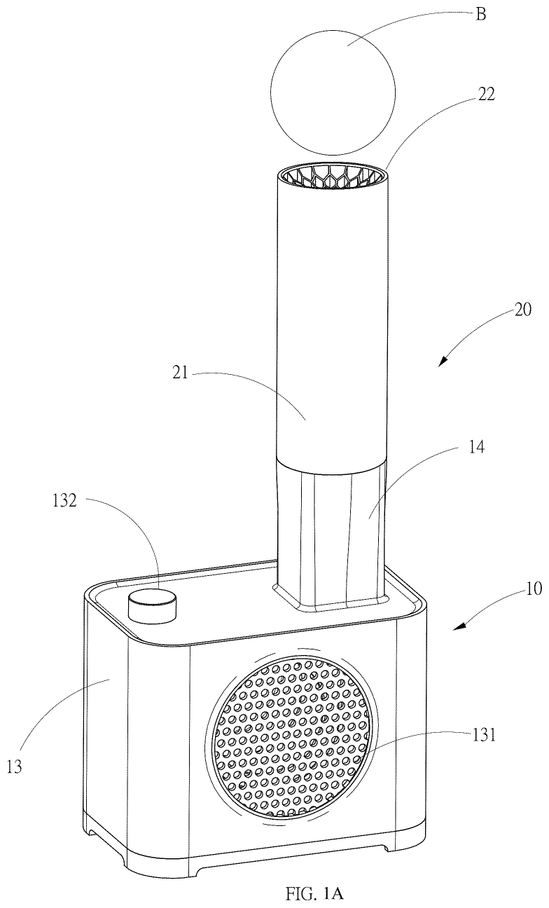

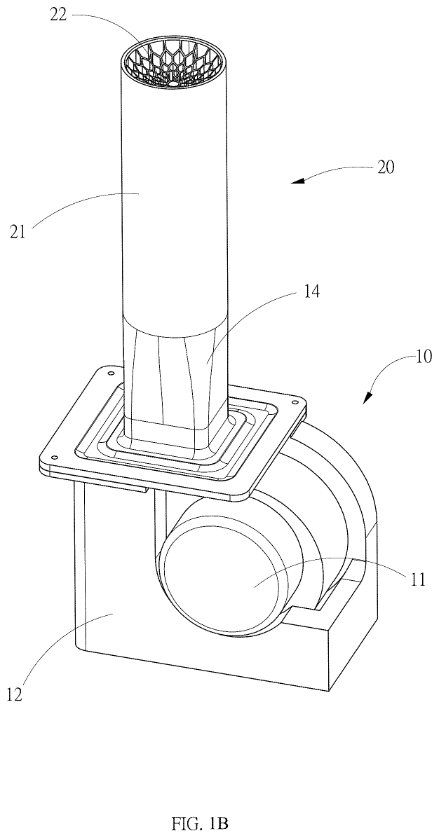

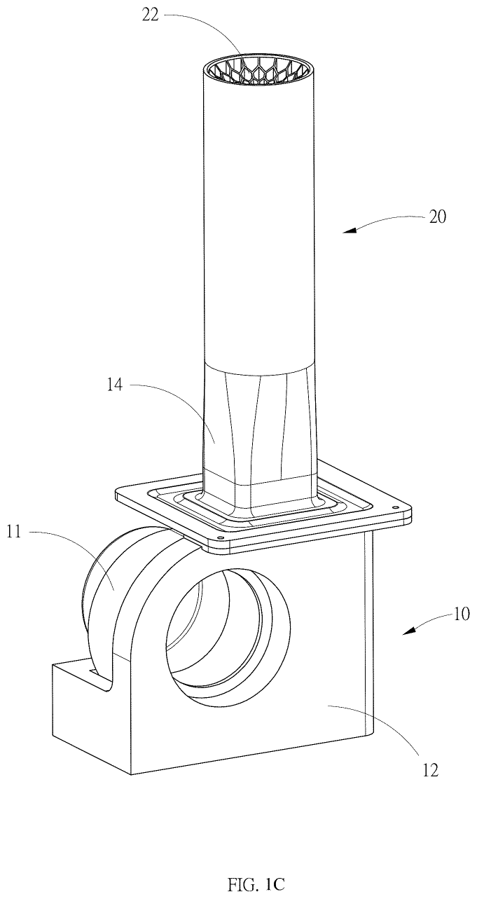

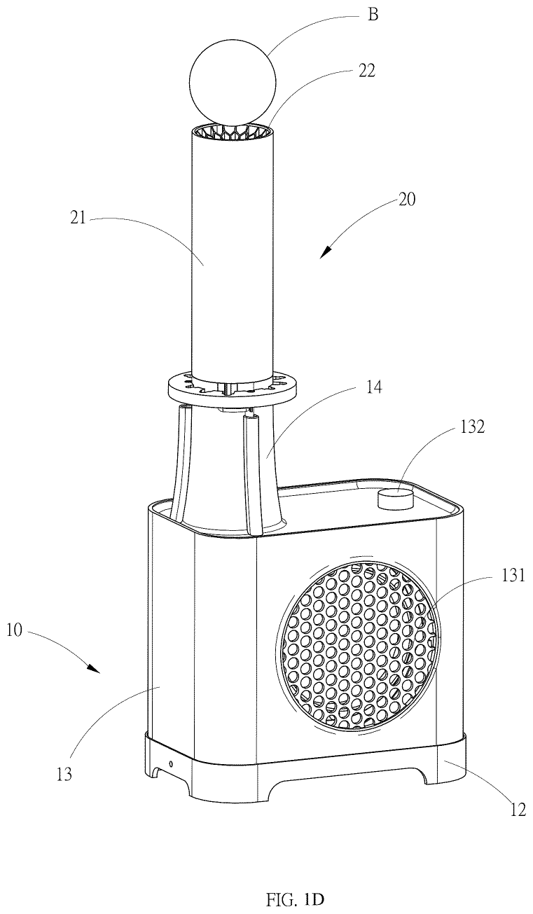

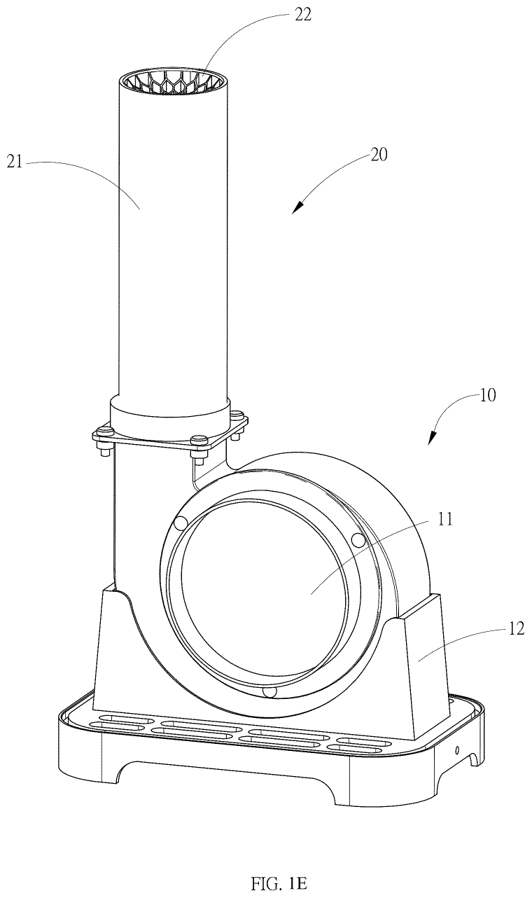

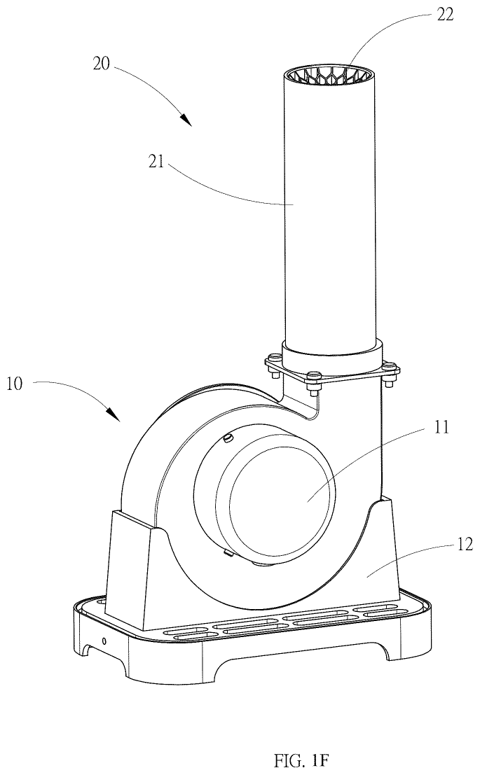

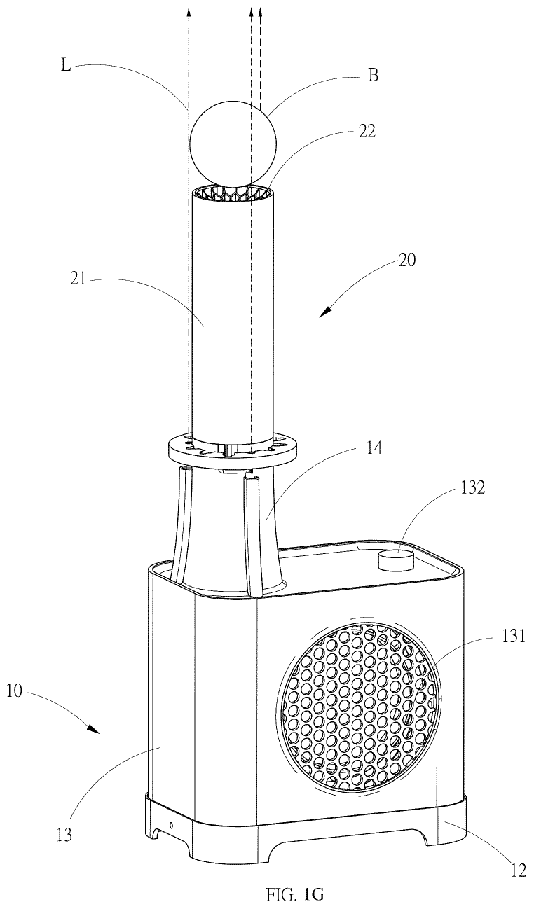

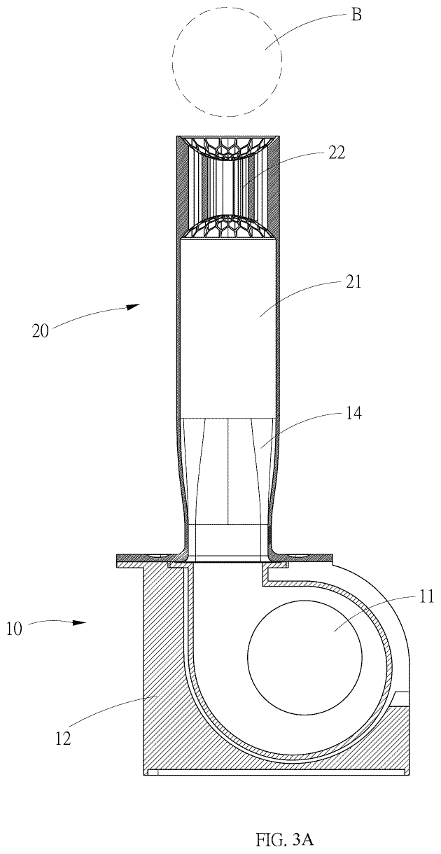

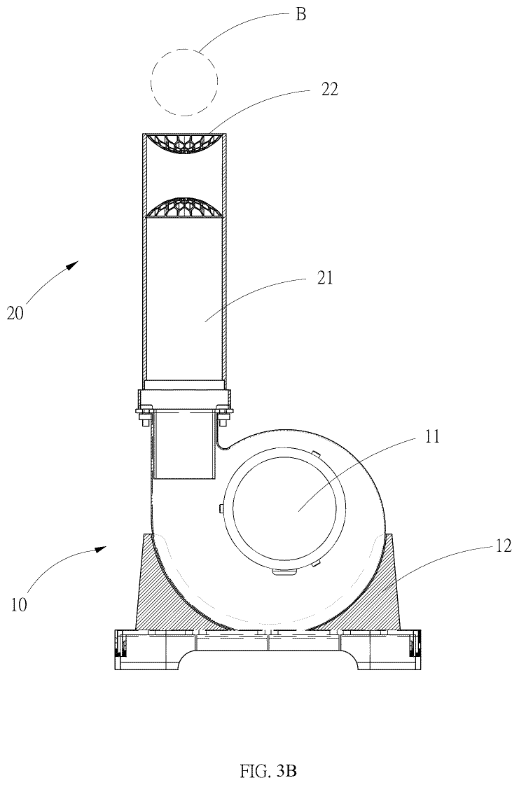

Reference is made to FIGS. 1A to 3B, which are multiple preferred embodiments of a pickleball testing device in accordance with the present invention. The pickleball testing device comprises an airflow generating unit 10 and an airflow circulating unit 20, wherein the airflow generating unit 10 comprises a turbine fan 11 and a base 12 that supports the turbine fan 11 and supplies power to the turbine fan 11. The turbine fan 11 and the base 12 are further covered by an outer casing 13 to ensure that a user does not directly touch the turbine fan 11. The upper side of the outer casing 13 of the airflow generating unit 10 features a protruding connection member 14 which is connected to the lower end of an airflow channel 21 of the airflow circulating unit 20 so that the airflow generating unit 10 and the airflow circulating unit 20 are connected. The airflow channel 21 is a hollow tubular column, and the turbine fan 11 can generate an airflow, then transfer the airflow to the connection member 14, causing the flow of air to move upward along the airflow channel 21. A pickleball B can be placed at the top of the airflow channel 21 and tested by the airflow.

The turbine fan 11 includes an air inlet and an air outlet. When the turbine fan 11 is turned on, the turbine fan 11 can draw air through the air inlet and accelerate the air to form the airflow through rotating blades inside the turbine fan 11, and output the airflow to the connection member 14.

The outer casing 13 completely covers the turbine fan 11, and the outer casing 13 includes an air inlet mask 131 corresponding to the air inlet of the turbine fan 11. The air inlet mask 131 contains multiple holes or grids, which allows air to smoothly enter the turbine fan 11 through the air inlet, but prevents the user from accidentally touching the turbine fan 11. The outer casing 13 has an opening corresponding to the air outlet of the turbine fan 11, and the opening is connected to the connection member 14, allowing the airflow from the turbine fan 11 to flow from the air outlet to the connection member 14 and continue upwardly toward the airflow channel 21.

The base 12 is connected to an external power source and is further electrically connected to the turbine fan 11, which supplies the power necessary for the turbine fan 11 to generate the airflow. In a preferred embodiment, with reference to FIG. 1A, the outer casing 13 also includes an airflow adjusting valve 132, which is signal-connected to the turbine fan 11 and can control the flow rate of the airflow generated by the turbine fan 11. Preferably, the airflow generated by the turbine fan 11 has a flow rate between 10 kilometers per hour and 100 kilometers per hour when exiting the airflow channel 21. In a preferred embodiment, the airflow adjusting valve 132 can adjust the flow rate of the airflow exiting the airflow channel 21 at a speed of 40 kilometers per hour, 50 kilometers per hour, 60 kilometers per hour, 70 kilometers per hour, or 80 kilometers per hour in stages.

Preferably, the outer casing 13 further includes a level (not shown) that can ensure that the pickleball testing device is placed horizontally on a plane with the airflow flowing vertically from the airflow channel 21 without any tilt to cause the airflow deviation. The level can be a water level, a bubble level, or a spirit level.

Preferably, the airflow channel 21 is a hollow cylinder, and the upper end of the airflow channel 21 contains multiple straightening tubes 22 extending along the axial direction of the airflow channel 21. The straightening tubes 22 divide the space at the upper end of the airflow channel 21 along the axial direction into multiple tubular channels. The straightening tubes 22 can control and guide the flow direction of the airflow, thereby reducing vortices or uneven flow of the airflow and improving the uniformity and stability of the airflow exiting from the airflow channel 21.

Preferably, the diameter of the cross-section of the airflow channel 21 is between 5 centimeters and 10 centimeters. Preferably, the straightening tubes 22 are symmetrically distributed within the airflow channel 21. Preferably, a cross-section formed by the straightening tubes 22 in the airflow channel 21 exhibits multi-axial symmetry. More preferably, the cross-section formed by the straightening tubes 22 in the airflow channel 21 exhibits multi-axial symmetry and simultaneously rotational symmetry about the axis of the airflow channel 21. More preferably, the cross-sectional area of each straightening tube 22 is less than 1 square centimeter, allowing the airflow to be effectively and uniformly straightened.

Preferably, the straightening tubes 22 in the airflow channel 21 are hexagonal, and the cross-section formed by the straightening tubes 22 resembles a honeycomb pattern.

Preferably, each of the straightening tubes 22 forms an end face at the upper end of the airflow channel 21, with the end face sloping downward from the outer wall of the airflow channel 21 toward the axis of the airflow channel 21 to form a concave surface, so that the pickleball B can be placed on the concave surface at the upper end of the airflow channel 21 without easily falling off before the airflow is generated.

Preferably, the pickleball testing device further comprises an imaging module (not shown), which has one or more cameras that can capture or record an image of the pickleball B floating above the airflow channel 21. Preferably, the camera is positioned directly above and to the side of the pickleball B facing the upper end of the airflow channel 21 to capture or record the image. Preferably, the camera is a high-speed camera. More preferably, the imaging module has an image recognition system which can detect the position of the pickleball B in the image and, in conjunction with one or more scales, quantitatively evaluate the floating state or wobbling of the pickleball B.

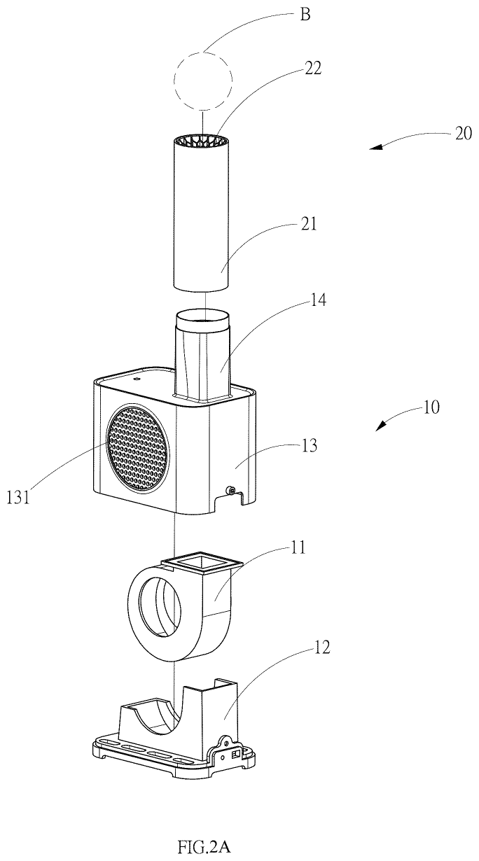

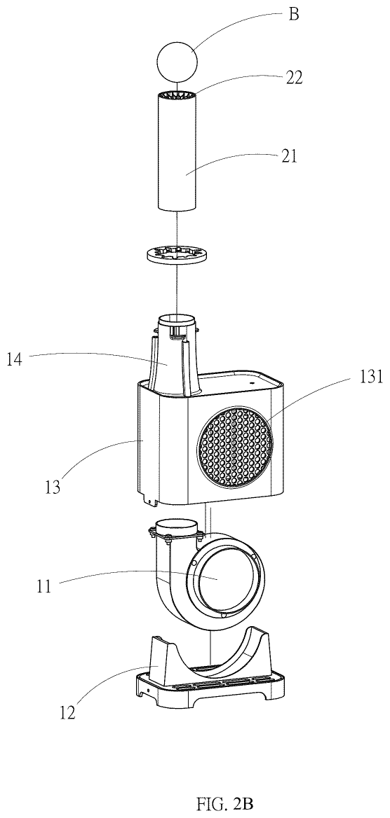

Preferably, with reference to FIGS. 1D and 2B, the pickleball testing device further comprises a photoelectric sensing device 30 that can detect the upper end of the airflow channel 21 and determine whether the wobbling and displacement of the pickleball B exceeds a range, and can also detect the rotation of the pickleball B to obtain information about the direction of rotation and the speed of rotation of the pickleball B. More preferably, the photoelectric sensing device contains a laser beam emitter and a laser beam receiver. In a preferred embodiment, with reference to FIGS. 1D, 1G, and 2B, the photoelectric sensing device 30 comprises multiple laser beam emitters attached to the connection member 14 and emitting a laser beam L toward the direction of the airflow channel 21, the laser beam L being parallel to the airflow channel 21. When the position of the pickleball B exceeds the range, the pickleball B will reflect the laser beam L emitted from the laser beam emitter, so that the user can easily recognize that the pickleball B has exceeded the range, or the laser beam receiver is blocked by the pickleball B and does not receive the laser beam L.

From the above description, it can be seen that the present invention achieves the following effects:

1. The pickleball testing device in accordance with the present invention enables the user to quickly confirm the condition of the pickleball in use, determine whether the pickleball has deformed or worn to an unusable condition, facilitate timely replacement of the ball, and ensure the fairness of the competition through real-time ball inspection.

2. The pickleball testing device in accordance with the present invention can assist manufacturers in quickly inspecting the quality of the manufactured pickleballs, ensuring that the pickleballs meet the specified standards and that the properties of each pickleball are consistent and stable.

3. The pickleball testing device in accordance with the present invention can be used to assist in the development and testing of pickleballs, to quickly obtain the condition of pickleballs with different processes, different materials, different hole sizes, different numbers of holes, and different manufacturing processes, thereby optimizing the pickleball.

It should be noted that, according to the explanations and elaborations in the above specification, those skilled in the art to which this disclosure relates may make changes and modifications to the above embodiments. Therefore, this disclosure is not limited to the specific embodiments disclosed and described above, and some equivalent modifications and changes to this disclosure should also be within the scope of protection of the claims of this disclosure. In addition, although certain specific terms are used in this disclosure, these terms are only for convenience of description and do not impose any limitations on the invention.

What is claimed is:

1. A pickleball testing device, comprising an airflow generating unit and an airflow circulating unit, wherein:
the airflow generating unit comprises a turbine fan and a base that supports the turbine fan and supplies power to the turbine fan, the turbine fan and the base being covered by an outer casing, and the upper side of the outer casing featuring a protruding connection member; and
the airflow circulating unit comprises an airflow channel that is a hollow tubular column, and the lower end of the airflow channel is connected to the connection member; wherein:
the turbine fan generates an airflow, then transfers the airflow to the connection member, causing the flow of air to move upward along the airflow channel.

2. The pickleball testing device according to claim 1, wherein the airflow channel is a hollow cylinder, and the upper end of the airflow channel contains multiple straightening tubes extending along the axial direction of the airflow channel, the straightening tubes dividing the airflow channel along the axial direction into multiple tubular channels.

3. The pickleball testing device according to claim 2, wherein the outer casing includes a level.

4. The pickleball testing device according to claim 2, wherein the diameter of the cross-section of the airflow channel is between 5 centimeters and 10 centimeters.

5. The pickleball testing device according to claim 4, wherein the cross-section formed by each straightening tube in the airflow channel exhibits multi-axial symmetry, and the cross-sectional area of each straightening tube is less than 1 square centimeter.

6. The pickleball testing device according to claim 4, wherein each of the straightening tubes forms an end face at the upper end of the airflow channel, with the end face sloping downward from the outer wall of the airflow channel toward the axis of the airflow channel to form a concave surface.

7. The pickleball testing device according to claim 1, wherein the airflow generated by the turbine fan has a flow rate between 10 kilometers per hour and 100 kilometers per hour when exiting the airflow channel.

8. The pickleball testing device according to claim 2, wherein the pickleball testing device comprises an imaging module, wherein the imaging module comprises one or more cameras facing the upper end of the airflow channel to capture or record an image, and an image recognition system to identify the image.

9. The pickleball testing device according to claim 4, wherein the pickleball testing device comprises an imaging module, wherein the imaging module comprises one or more cameras facing the upper end of the airflow channel to capture or record an image, and an image recognition system to identify the image.

10. The pickleball testing device according to claim 5, wherein the pickleball testing device comprises an imaging module, wherein the imaging module comprises one or more cameras facing the upper end of the airflow channel to capture or record an image, and an image recognition system to identify the image.

11. The pickleball testing device according to claim 6, wherein the pickleball testing device comprises an imaging module, wherein the imaging module comprises one or more cameras facing the upper end of the airflow channel to capture or record an image, and an image recognition system to identify the image.

12. The pickleball testing device according to claim 7, wherein the pickleball testing device comprises an imaging module, wherein the imaging module comprises one or more cameras facing the upper end of the airflow channel to capture or record an image, and an image recognition system to identify the image.

13. The pickleball testing device according to claim 1, wherein the pickleball testing device comprises a photoelectric sensing device for detecting the position at the upper end of the airflow channel, the photoelectric sensing device containing a laser beam emitter.

14. The pickleball testing device according to claim 2, wherein the pickleball testing device comprises a photoelectric sensing device for detecting the position at the upper end of the airflow channel, the photoelectric sensing device containing a laser beam emitter.

15. The pickleball testing device according to claim 4, wherein the pickleball testing device comprises a photoelectric sensing device for detecting the position at the upper end of the airflow channel, the photoelectric sensing device containing a laser beam emitter.

16. The pickleball testing device according to claim 8, wherein the pickleball testing device comprises a photoelectric sensing device for detecting the position at the upper end of the airflow channel, the photoelectric sensing device containing a laser beam emitter.

17. The pickleball testing device according to claim 12, wherein the pickleball testing device comprises a photoelectric sensing device for detecting the position at the upper end of the airflow channel, the photoelectric sensing device containing a laser beam emitter.

18. The pickleball testing device according to claim 13, wherein the laser beam emitter is attached to the connection member and emits a laser beam toward the direction of the airflow channel, and the laser beam is parallel to the airflow channel.

19. The pickleball testing device according to claim 15, wherein the laser beam emitter is attached to the connection member and emits a laser beam toward the direction of the airflow channel, and the laser beam is parallel to the airflow channel.

20. The pickleball testing device according to claim 17, wherein the laser beam emitter is attached to the connection member and emits a laser beam toward the direction of the airflow channel, and the laser beam is parallel to the airflow channel.
